(19) United States
(12) Patent Application Publication
(10) Pub. No.: US 2022/0247684 A1
(43) Pub. Date: Aug. 4, 2022

(54) METHOD AND COMPUTING DEVICE FOR ENFORCING FUNCTIONAL FILTERING RULES IN A POD INFRASTRUCTURE

(71) Applicant: KALOOM INC., Montreal (CA)

(72) Inventors: Per ANDERSSON, Montreal (CA); Suresh KRISHNAN, Suwanee, GA (US); Abdallah CHATILA, Verdun (CA)

(21) Appl. No.: 17/586,855

(22) Filed: Jan. 28, 2022

Related U.S. Application Data
(60) Provisional application No. 63/144,308, filed on Feb. 1, 2021.

(51) Int. Cl. H04L 45/745

(52) U.S. Cl. CPC H04L 45/745

(57) ABSTRACT

The present method and computer device store a plurality of functional filtering rules in memory, each functional filtering rule being based on at least one of a namespace and a pod type. A data structure providing a mapping between pods and Internet Protocol (IP) addresses is stored in the memory. Upon receipt or transmission of an IP packet, a source IP address and a destination IP address are extracted from the IP packet. A source pod corresponding to the source IP address and a destination pod corresponding to the destination IP address are determined using the data structure. Each pod belongs to one of a plurality of namespaces and one of a plurality of pod types. The method and computer further identify and apply a functional filtering rule among the plurality of functional filtering rules that is matched for the source pod and destination pod respective namespaces and pod types.

### TECHNICAL FIELD

The present disclosure relates to packet filtering policies in a large scale multi-device application deployment. More specifically, the present disclosure relates to a method and computing device for enforcing functional filtering rules in a pod infrastructure.

### BACKGROUND

Kubernetes is an example of a large scale multi-device application deployment framework. In Kubernetes, the application deployment consists in deploying pods. A computing device in Kubernetes is referred to as a node. A pod consists of one or more containers that are co-located on the same node and share resources. Each container executes software and the combination of the software(s) executed by the container(s) of a pod implements an application. One or more pod of the same type can be executed concurrently on the same node, as well as on different nodes.

In Kubernetes, each pod on a node is allocated at least one Internet Protocol (IP) address for communicating with other entities outside the node, including pods executing on other nodes. In order to enforce security, packet filtering rules are implemented to control the traffic to and from a node. The packet filtering rules determine if a packet received by the node is admitted or blocked. The packet filtering rules also determine if a packet generated by the node is transmitted to another entity or blocked. Traditional packet filtering rules are directly based on characteristics of the IP packets, such as the source and destination IP addresses of the IP packets, etc.

The Kubernetes framework also provides the capability of defining functional filtering rules, representative of the functional architecture of a pod deployment. A functional filtering rule is directly based on characteristics of the pods, such as the namespace of a pod and the pod type of a pod. Thus, with a functional filtering rule, a group of pods sharing common properties (e.g. a given namespace and one or more associated pod type) is easily targeted. By contrast, targeting the group of pods sharing the common properties with traditional IP packet filtering rules directly based on the IP addresses allocated to the group of pods does not scale well. This is due to the fact that the common properties are not represented in the IP addresses. Therefore, complex traditional packet filtering rules need to be generated, targeting the IP addresses allocated to the group of pods. The set of traditional packet filtering rules needs to be updated regularly, when pods matching the common properties are created or deleted, to takin into consideration the IP addresses associated to the created or deleted pods.

However, in the current Kubernetes implementation, it is not possible to directly enforce functional filtering rules on IP packets received or transmitted via a communication interface of a node executing a plurality of pods. The functional filtering rules are translated into traditional IP packet filtering rules, which are enforced on the IP packets received or transmitted via a communication interface. As mentioned previously, the usage of the traditional IP packet filtering rules does not scale well for a pod infrastructure.

Therefore, there is a need for a method and computing device for enforcing functional filtering rules in a pod infrastructure.

### SUMMARY

According to a first aspect, the present disclosure relates to a method for enforcing functional filtering rules in a pod infrastructure. The method comprises storing in a memory of a computing device a plurality of functional filtering rules, each functional filtering rule being based on at least one of a namespace and a pod type, the namespace being one of a plurality of namespaces and the pod type being one of a plurality of pod types. The method comprises storing in the memory of the computing device a data structure providing a mapping between pods and Internet Protocol (IP) addresses. The method comprises determining that an IP packet has been received via a communication interface of the computing device or is to be transmitted via the communication interface of the computing device. The method comprises extracting by a processing unit of the computing device a source IP address and a destination IP address of the IP packet. The method comprises determining by the processing unit of the computing device a source pod corresponding to the source IP address using the mapping data structure, the source pod belonging to a source namespace among the plurality of namespaces and a source pod type among the plurality of pod types. The method comprises determining by the processing unit of the computing device a destination pod corresponding to the destination IP address using the mapping data structure, the destination pod belonging to a destination namespace among the plurality of namespaces and a destination pod type among the plurality of pod types. The method comprises identifying by the processing unit of the computing device a functional filtering rule among the plurality of functional filtering rules that is matched for the source namespace, the source pod type, the destination namespace and the destination pod type. The method comprises applying by the processing unit of the computing device the matched functional filtering rule to the IP packet.

According to a second aspect, the present disclosure relates to a computing device. The computing device comprises memory, a communication interface, and a processing unit comprising at least one processor. The memory stores a plurality of functional filtering rules, each functional filtering rule being based on at least one of a namespace and a pod type, the namespace being one of a plurality of namespaces and the pod type being one of a plurality of pod types. The memory stores a data structure providing a mapping between pods and Internet Protocol (IP) addresses. The processing unit determines that an IP packet has been received via a communication interface of the computing device or is to be transmitted via the communication interface of the computing device. The processing unit extracts a source IP address and a destination IP address of the IP packet. The processing unit determines a source pod corresponding to the source IP address using the mapping data structure, the source pod belonging to a source namespace among the plurality of namespaces and a source pod type among the plurality of pod types. The processing unit determines a destination pod corresponding to the destination IP address using the mapping data structure, the destination pod belonging to a destination namespace among the plurality of namespaces and a destination pod type among the plurality of pod types. The processing unit identifies a functional filtering rule among the plurality of functional filtering rules that is matched for the source namespace, the source pod type, the destination namespace and the destination pod type. The processing unit applies the matched functional filtering rule to the IP packet.

According to a third aspect, the present disclosure relates to a method for enforcing functional filtering rules in a pod infrastructure supporting Internet Protocol (IP) address domains. The method comprises storing in a memory of a computing device a plurality of functional filtering rules, each functional filtering rule being based on at least one of a namespace and a pod type, the namespace being one of a plurality of namespaces and the pod type being one of a plurality of pod types. The method comprises storing in the memory of the computing device a data structure providing a mapping between pods and combinations of an Internet Protocol (IP) address and an IP address domain, the IP address domain being one of a plurality of IP address domains. The method comprises determining that an IP packet has been received via a communication interface of the computing device or is to be transmitted via the communication interface of the computing device. The method comprises determining by the processing unit of the computing device an IP address domain among the plurality of IP address domains associated to the communication interface. The method comprises extracting by the processing unit of the computing device a source IP address and a destination IP address of the IP packet. The method comprises determining by the processing unit of the computing device a source pod corresponding to the combination of the source IP address and the determined IP address domain using the mapping data structure, the source pod belonging to a source namespace among the plurality of namespaces and a source pod type among the plurality of pod types. The method comprises determining by the processing unit of the computing device a destination pod corresponding to the combination of the destination IP address and the determined IP address domain using the mapping data structure, the destination pod belonging to a destination namespace among the plurality of namespaces and a destination pod type among the plurality of pod types. The method comprises identifying by the processing unit of the computing device a functional filtering rule among the plurality of functional filtering rules that is matched for the source namespace, the source pod type, the destination namespace and the destination pod type. The method comprises applying by the processing unit of the computing device the matched functional filtering rule to the IP packet.

According to a fourth aspect, the present disclosure relates to a computing device. The computing device comprises memory, a communication interface, and a processing unit comprising at least one processor. The memory stores a plurality of functional filtering rules, each functional filtering rule being based on at least one of a namespace and a pod type, the namespace being one of a plurality of namespaces and the pod type being one of a plurality of pod types. The memory also stores a data structure providing a mapping between pods and combinations of an Internet Protocol (IP) address and an IP address domain, the IP address domain being one of a plurality of IP address domains. The processing unit determines that an IP packet has been received via the communication interface or is to be transmitted via the communication interface. The processing unit determines an IP address domain among the plurality of IP address domains associated to the communication interface. The processing unit extracts a source IP address and a destination IP address of the IP packet. The processing unit determines a source pod corresponding to the combination of the source IP address and the determined IP address domain using the mapping data structure, the source pod belonging to a source namespace among the plurality of namespaces and a source pod type among the plurality of pod types. The processing unit determines a destination pod corresponding to the combination of the destination IP address and the determined IP address domain using the mapping data structure, the destination pod belonging to a destination namespace among the plurality of namespaces and a destination pod type among the plurality of pod types. The processing unit identifies a functional filtering rule among the plurality of functional filtering rules that is matched for the source namespace, the source pod type, the destination namespace and the destination pod type. The processing unit applies the matched functional filtering rule to the IP packet.

### BRIEF DESCRIPTION OF THE DRAWINGS

Embodiments of the disclosure will be described by way of example only with reference to the accompanying drawings, in which:

FIG. 1 represents a computing device;

FIG. 2 represents a deployment of pods on several computing devices;

FIG. 3 represents a method for creating a pod on one of the computing devices represented in FIG. 2;

FIG. 4 represents one of the computing devices of FIG. 2 executing a filtering software;

FIG. 5 represents a method implemented by the computing device of FIG. 4 for enforcing functional filtering rules in a pod infrastructure;

FIG. 6 represents the computing devices of FIG. 4 with two communication interfaces; and

FIG. 7 represents a method implemented by the computing device of FIG. 6 for enforcing functional filtering rules in a pod infrastructure supporting Internet Protocol (IP) address domains.

### DETAILED DESCRIPTION

The foregoing and other features will become more apparent upon reading of the following non-restrictive description of illustrative embodiments thereof, given by way of example only with reference to the accompanying drawings.

Various aspects of the present disclosure generally address one or more of the problems related to the usage of pod functional filtering rules directly applied to Internet Protocol (IP) packets in the context of a pod deployment framework (e.g. Kubernetes). The present disclosure supports a pod deployment framework with a single IP address domain and a pod deployment framework with a plurality of IP address domains.

In the rest of the description, the Kubernetes framework will be used to describe the deployment of a pod infrastructure and the usage of pod functional filtering rules applied to IP packets. In Kubernetes, a pod is a containerized software application, implementing one or more software container executing on the same computing device. The present disclosure can be extended to another applicative deployment framework supporting the notion of a pod as a containerized software application, and further supporting the other functionalities of Kubernetes used for the usage of functional filtering rules (as described in the following).

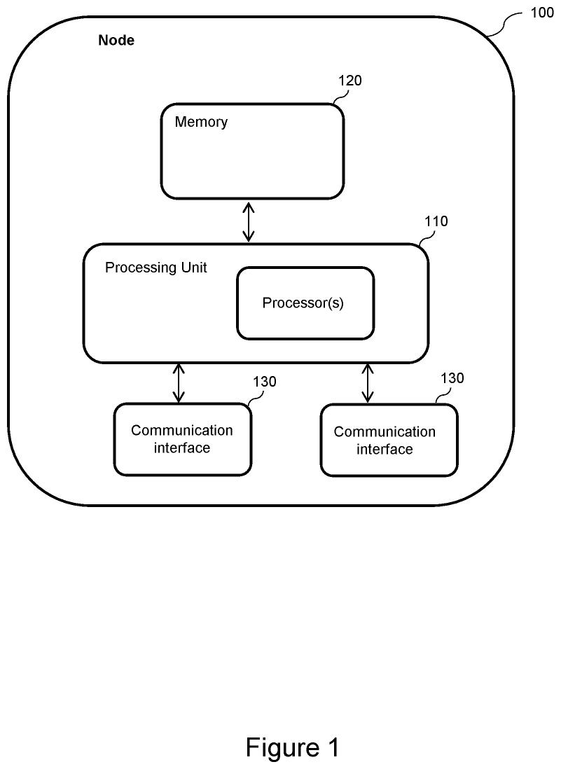

Referring now to FIG. 1, a computing device 100 is illustrated. In the rest of the description, the computing device 100 will be referred to as a node, which is the terminology generally used in the Kubernetes framework for designating a computing device executing one or more pod. Examples of nodes 100 include (without limitations) a switch, a router, a server, a desktop, a mobile computing device (e.g. smartphone or tablet), etc.

The node 100 comprises a processing unit 110, memory 120, and at least one communication interface 130. The node 100 may comprise additional components (not represented in FIG. 1 for simplification purposes). For example, the node 100 may include a user interface and/or a display.

The processing unit 110 comprises one or more processor capable of executing instructions of a computer program (a single processor is represented in FIG. 1 for illustration purposes). Each processor may further comprise one or several cores. The processing unit 110 may also include one or more dedicated processing components (e.g. a network processor, an Application Specific Integrated Circuits (ASIC), etc.) for performing specialized networking functions (e.g. packet forwarding).

The memory 120 stores instructions of computer program(s) executed by the processing unit 110, data generated by the execution of the computer program(s) by the processing unit 110, data received via the communication interface(s) 130, etc. Only a single memory 120 is represented in FIG. 1, but the node 100 may comprise several types of memories, including volatile memory (such as Random Access Memory (RAM)) and non-volatile memory (such as a hard drive, Erasable Programmable Read-Only Memory (EPROM), Electrically-Erasable Programmable Read-Only Memory (EEPROM), etc.).

Each communication interface 130 allows the node 100 to exchange data with other devices (two communication interfaces are represented in FIG. 1 for illustration purposes). Examples of communication interfaces 130 of the wireline type include standard (electrical) Ethernet ports, fiber optic ports, ports adapted for receiving Small Form-factor Pluggable (SFP) units, etc. The communication interface 130 may also be of the wireless type (e.g. a Wi-Fi interface). The communication interface 130 comprises a combination of hardware and software executed by the hardware, for implementing the communication functionalities of the communication interface 130. Alternatively, the combination of hardware and software for implementing the communication functionalities of the communication interface 130 is at least partially included in the processing unit 110.

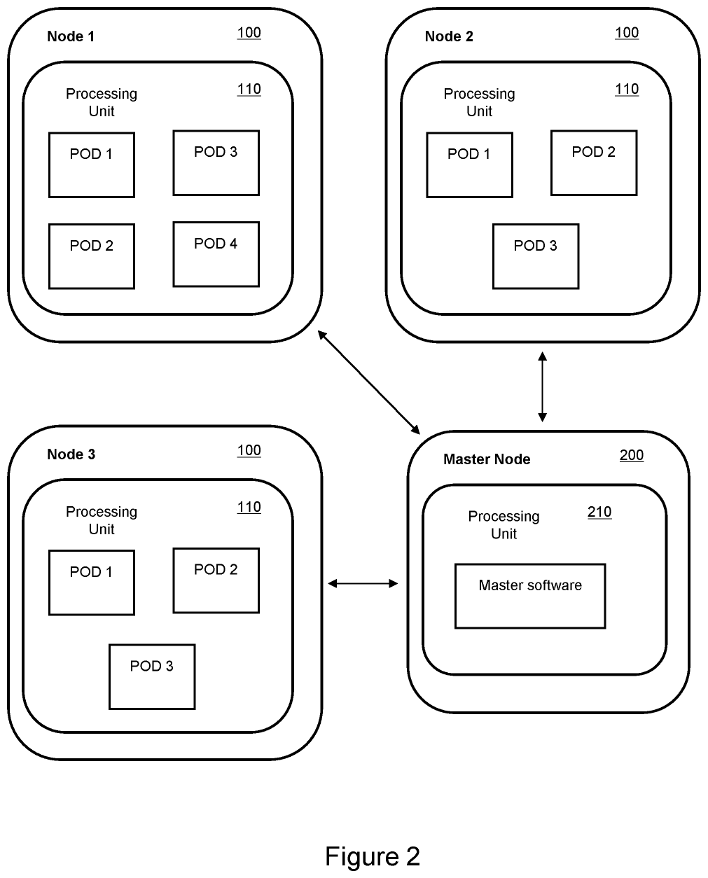

Reference is now made concurrently to FIGS. 1 and 2. FIG. 2 illustrates an architecture with three nodes 100 (respectively Node 1, Node 2 and Node 3) executing pods under the control of a master node 200. In the rest of the description, a node 100 executing pods (under the control of the master node 200) will be referred to simply as a node, by contrast to the master node.

The hardware architecture of the master node 200 is similar to the hardware architecture of the node 100 represented in FIG. 1. The master node 200 comprises a processing unit 210 executing a master software for managing (configuration, creation, execution, deletion, etc.) the pods on the nodes 100. The management of the pods by the master node 200 is based on an exchange of data between the master node 200 and the nodes 100, which is out of the scope of the presently claimed invention. Although not represented in FIG. 2 for simplification purposes, each node 100 executes a client software which interacts with the master software for implementing the management of the pods on the nodes 100.

For illustration purposes, Node 1 executes 4 pods (respectively POD 1, POD 2, POD 3 and POD 4), Node 2 executes 3 pods (respectively POD 1, POD 2 and POD 3) and Node 3 executes 3 pods (respectively POD 1, POD 2 and POD 3). Furthermore, although 3 nodes 100 have been represented in FIG. 2, any number of nodes 100 may be operating under the control of the master node 200.

The Kubernetes framework provides the functionality of namespaces, which is usually used in environments comprising a large number of user. Namespaces provide a scope for names of resources (e.g. pods, services, etc.) used in the Kubernetes framework. Names of resources are unique within a given namespace, but are not unique across namespaces.

Namespaces can be used to define resource quota limitations, which are enforced under the control of the master node 200. For example, a first namespace (corresponding to a first group of users) has a limit of 30% of the processing power and 30% of the memory provided by all the nodes 100 under the control of the master node 200, while a second namespace (corresponding to a second group of users) has a limit of 40% of the processing power and 50% of the memory provided by all the nodes 100 under the control of the master node 200. In another example, the first namespace is allocated 25% of all the nodes 100 under the control of the master node 200, while the second namespace is allocated 50% of all the nodes 100 under the control of the master node 200. Namespaces can also be used to enforce security policies, for example by reducing the privileges of a group of users belonging to a given namespace.

The Kubernetes framework also provides the functionality of pod templates. A pod template is a specification for creating pods according to the pod template. Each pod template is a text file which defines how the pods created from the pod template behave. In particular, the pod template defines the number of software containers implemented by the pod, and for each container the particular software program(s) executed by the container. Each pod template comprises a name which identifies the pod template. In the rest of the description, the name of the pod template will be referred to as the pod type. Thus, a given pod type identifies a corresponding given pod template. Instances of pods corresponding to the given pod type will be referred to as pods of the given pod type. Several pods of the same pod type can be executed on different nodes 100 concurrently. Additionally, several pods of the same pod type can be executed on the same node 100 concurrently.

The notions of namespace and pod type are interrelated. A pod template and the associated pod type are generated in the context of a given namespace. Since the namespace and pod type consist of names, they are respectively implemented by a string, which may have a predefined length or not. For example, the namespace is a string having a maximum of N characters (e.g. 30) and the pod type is a string having a maximum of T characters (e.g. 20). The namespace strings and pod type strings may be converted to a more effective format (than strings) for internal storage and internal processing. The string format is used by users and allows the creation, modification, deletion, etc. of namespaces and pod types by the users (e.g. by an administrator using a user interface of the master node 200).

Following are exemplary namespaces and pod types corresponding to the pods represented in FIG. 2. A first namespace named NSpace_A is generated. Within the namespace NSpace_A, two pod types respectively named app_a01 and app_a02 are generated. Pod type app_a01 identifies a pod template t_a01 and pod type app_a02 identifies a pod template t_a02. POD 1 on Node 1 belongs to namespace NSpace_A and corresponds to pod type app_a01 (POD 1 on Node 1 implements the pod template t_a01). POD 2 on Node 1 belongs to namespace NSpace_A and also corresponds to pod type app_a01 (POD 2 on Node 1 implements the pod template t_a01). POD 1 and POD 2 illustrate two instances of the same namespace/pod type executing concurrently on the same node. POD 4 on Node 1 belongs to namespace NSpace_A and corresponds to pod type app_a02 (POD 4 on Node 1 implements the pod template t_a02). POD 1 on Node 2 belongs to namespace NSpace_A and corresponds to pod type app_a01 (POD 1 on Node 2 implements the pod template t_a01). POD 1 on Node 3 belongs to namespace NSpace_A and corresponds to pod type app_a02 (POD 1 on Node 3 implements the pod template t_a02).

A second namespace named NSpace_B is generated. Within this namespace NSpace_B, two pod types respectively named app_b01 and app_b02 are generated. Pod type “app_b01 identifies a pod template t_b01 and pod type app_b02 identifies a pod template t_b02. POD 3 on Node 1 belongs to namespace NSpace_B and corresponds to pod type app_b01 (POD 3 on Node 1 implements the pod template t_b01). POD 2 on Node 2 belongs to namespace NSpace_B and corresponds to pod type app_b02 (POD 2 on Node 2 implements the pod template t_b02). POD 3 on Node 2 belongs to namespace NSpace_B and corresponds to pod type app_b01 (POD 3 on Node 2 implements the pod template t_b01). POD 2 on Node 3 belongs to namespace NSpace_B and corresponds to pod type app_b02 (POD 2 on Node 3 implements the pod template t_b02).

A third namespace named NSpace_C is generated. Within this namespace NSpace_C, one pod type named app_c01 is generated. Pod type app_c01 identifies a pod template t_c01. POD 3 on Node 3 belongs to namespace NSpace_C and corresponds to pod type app_c01 (POD 3 on Node 3 implements the pod template t_c01).

In a first implementation, a pod type is unique among all the defined namespaces. In a second implementation, a pod type is unique within a given namespace (the same pod type can be used in two different namespaces). In both implementations, the combination of the pod type and the namespace in which it has been defined is unique.

The number of namespaces and the number of pod types per namespace in the previous example are for illustration purposes only, and may vary with each specific implementation of a pod infrastructure. The following table summarizes the previous example.

TABLE 1

| Pod | Namespace | Pod type |
|---|---|---|
| Node 1/POD 1 | NSpace_A | app_a01 |
| Node 1/POD 2 | NSpace_A | app_a01 |
| Node 1/POD 3 | NSpace_B | app_b01 |
| Node 1/POD 4 | NSpace_A | app_a02 |
| Node 2/POD 1 | NSpace_A | app_a01 |
| Node 2/POD 2 | NSpace_B | app_b02 |
| Node 2/POD 3 | NSpace_B | app_b01 |
| Node 3/POD 1 | NSpace_A | app_a02 |
| Node 3/POD 2 | NSpace_B | app_b02 |
| Node 3/POD 3 | NSpace_C | app_c01 |

The namespaces and pod types represented In Table 1 may be encoded in various data formats, for example strings which are easily manipulated by end users when managing the namespaces and pod types. However, the namespaces and pod types may also be encoded in a more effective format (than strings) by the Kubernetes framework for internal use. In the rest of the description, the reference to a namespace and a pod type may encompass any format used by Kubernetes for managing namespaces and pod types.

The Kubernetes framework further provides the functionality of allocating at least one Internet Protocol (IP) address to each pod. Thus, a pod may have an IPv4 address only, an IPv6 address only, or an IPv4 and an IPv6 address. Two pods executing on the same node 100 generally exchange data directly using their respective IP addresses. Two pods executing on two different nodes 100 exchange data using their respective IP addresses, and through the respective communication interfaces 130 of the two different nodes.

The following paragraphs describe an exemplary implementation for the generation of IPv6 addresses allocated to the pods. In the Kubernetes terminology, a cluster is a group of nodes 100 and master node(s) 200. The cluster is allocated an IPv6 prefix; for example 2001:db80:aabb/48. Each node 100 in the cluster is allocated an IPv6 prefix derived from the IPv6 prefix of the cluster; for example 2001:db80:aabb:1001/64 for Node 1, 2001:db80:aabb:1002/64 for Node 2 and 2001:db80:aabb:1003/64 for Node 3. In the rest of the description, the IPv6 prefix allocated to each node 100 will be referred to as the IPv6 base prefix.

Each pod on a given node 100 is also allocated a pod identifier of a pre-defined number of bits (e.g. 14 or 16). Within a given node 100, the pod identifiers are unique. However, the same pod identifier can be used on different nodes 100. For example, the pod identifiers 0x0001, 0x0002, 0x0003 and 0x0004 are respectively allocated to pods POD 1, POD 2, POD 3 and POD 4 on node 1. The pod identifiers 0x0001, 0x0002 and 0x0003 are respectively allocated to pods POD 1, POD 2 and POD 3 on node 2. The pod identifiers 0x0001, 0x0002 and 0x0003 are respectively allocated to pods POD 1, POD 2 and POD 3 on node 3.

The Kubernetes framework allocates a 128 bits Universal Unique Identifier (UUID) to every object of a cluster, including the pods. Thus, in an exemplary implementation, the pod identifier of a pod is generated by calculating a hash of the UUID allocated to the pod. The input of the hash function is the 128 bits UUID and the output of the hash function is the 14 (or 16) bits pod identifier. The hash function is designed so that two different values of UUID do no generate the same output when applied the hash function.

A usual way of generating an IPv6 address for a pod is to combine the IPv6 based prefix of the node 100 on which the pod is executing with the unique identifier allocated to the pod. The following table, based on table 1, illustrates the usual way of generating an IPv6 address for a pod.

TABLE 2

| Pod | Node IPv6 base prefix | Pod identifier | IPv6 address |
|---|---|---|---|
| Node 1/POD 1 | 2001:db80:aabb:1001/64 | 0x0001 | 2001:db80:aabb:1001::0001/128 |
| Node 1/POD 2 | 2001:db80:aabb:1001/64 | 0x0002 | 2001:db80:aabb:1001::0002/128 |
| Node 1/POD 3 | 2001:db80:aabb:1001/64 | 0x0003 | 2001:db80:aabb:1001::0003/128 |
| Node 1/POD 4 | 2001:db80:aabb:1001/64 | 0x0004 | 2001:db80:aabb:1001::0004/128 |
| Node 2/POD 1 | 2001:db80:aabb:1002/64 | 0x0001 | 2001:db80:aabb:1002::0001/128 |
| Node 2/POD 2 | 2001:db80:aabb:1002/64 | 0x0002 | 2001:db80:aabb:1002::0002/128 |
| Node 2/POD 3 | 2001:db80:aabb:1002/64 | 0x0003 | 2001:db80:aabb:1002::0003/128 |
| Node 3/POD 1 | 2001:db80:aabb:1003/64 | 0x0001 | 2001:db80:aabb:1003::0001/128 |
| Node 3/POD 2 | 2001:db80:aabb:1003/64 | 0x0002 | 2001:db80:aabb:1003::0002/128 |
| Node 3/POD 3 | 2001:db80:aabb:1003/64 | 0x0003 | 2001:db80:aabb:1003::0003/128 |

As illustrated in table 2, the IPv6 addresses allocated to the pods do not take into consideration the namespace and pod type of the pods.

In the rest of the description, IPv6 addresses will be used to illustrate the functionalities provided by the present disclosure. However, a person skilled in the art would readily adapt these functionalities to IPv4 addresses. For example, an IPv4 address is generated for a pod by combining an IPv4 prefix and the pod identifier (or a hash of the pod identifier if the pod identifier is encoded on too many bits).

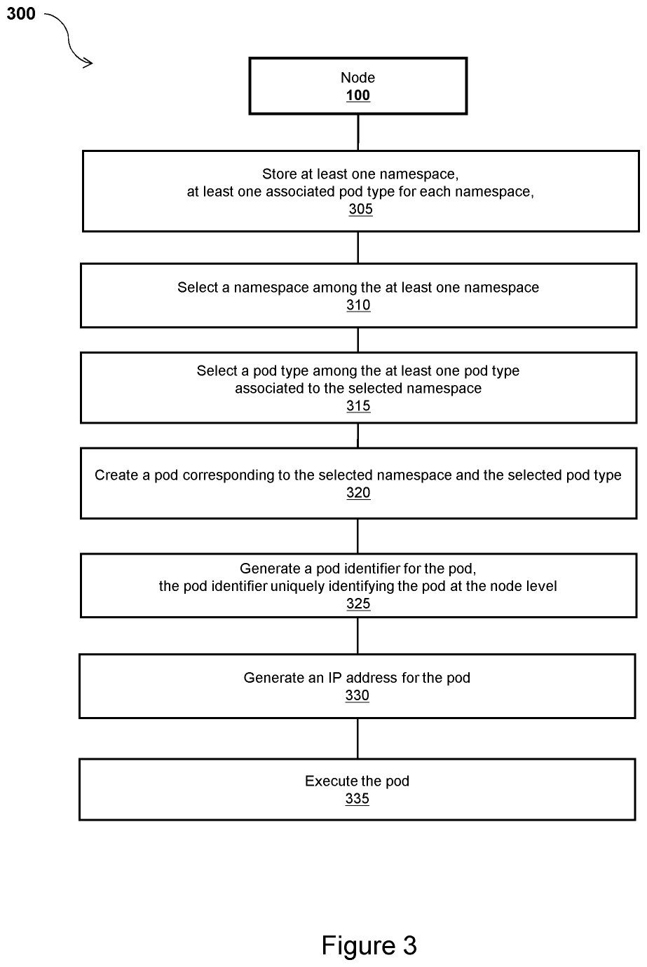

Referring now concurrently to FIGS. 1, 2 and 3, a method 300 for creating a pod is illustrated in FIG. 3. At least some of the steps of the method 300 are performed by each node 100 represented in FIG. 2.

The method 300 comprises the step 305 of storing at least one namespace, and at least one associated pod type for each namespace. Step 305 is executed by the processing unit 110 of the node 100.

For example, each namespace is defined at the master node 200 by an administrator of the cluster. For each namespace, the associated one or more pod type is also defined at the master node 200 by the administrator (or a simple user) of the cluster. The one or more namespace and each corresponding one or more pod type are transmitted from the master node 200 to each node 100, received at each node 100 via the communication interface 130, and stored in the memory 120. An exemplary set of namespaces and corresponding pod types stored in the memory 120 of nodes Node 1, Node 2 and Node 3 has been described previously.

The method 300 comprises the step 310 of selecting a namespace among the at least one namespace stored in the memory 120. Step 310 is executed by the processing unit 110 of the node 100.

The method 300 comprises the step 315 of selecting a pod type among the at least one pod type (stored in the memory 120) associated to the namespace selected at step 310. Step 315 is executed by the processing unit 110 of the node 100. For example, if the namespace NSpace_A is selected at step 310, then one of the pod types app_a01, app_a02 or app_a03 is selected at step 315.

The method 300 comprises the step 320 of creating a pod corresponding to the namespace selected at step 310 and the pod type selected at step 315. Step 320 is executed by the processing unit 110 of the node 100. The creation of a pod, for example in the context of the Kubernetes framework, is well known in the art and is out of the scope of the present disclosure. The creation of the pod may for example include the allocation of hardware and/or software resources, the transfer of software instructions (associated to the pod type selected at step 315) from a permanent storage memory (e.g. a hard disk drive of the node 100) to a temporary execution memory (e.g. a Random-Access Memory (RAM) of the node 100), etc. The creation of the pod is based on the pod template corresponding to the selected namespace and pod type. For example, if the namespace NSpace_A is selected at step 310 and the pod type app_a02 is selected at step 315, then the pod created at step 320 is compliant with the template t_a02.

The method 300 comprises the step 325 of generating a pod identifier for the pod created at step 320. Step 325 is executed by the processing unit 110 of the node 100. The pod identifier has a pre-defined number of bits and uniquely identifies the pod created at step 320 at the node 100 level (any two pods created on the same node 100 have respective different pod identifiers). Exemplary implementations of the determination of the pod identifier have been described previously. Step 325 may be integrated to step 320 or performed independently of step 320 (e.g. by the Kubernetes framework or by a dedicated mechanism independent of the Kubernetes framework).

The method 300 comprises the step 330 of generating an IP address for the pod (created at step 320). Step 330 is executed by the processing unit 110 of the node 100. The IP address consists of an IPv6 address or an IPv4 address.

The method 300 comprises the step 335 of executing the pod created at step 320. Step 335 is executed by the processing unit 110 of the node 100. The execution of a pod is well known in the art, for example in the context of the Kubernetes framework. The execution of the pod comprises executing a containerized software application. The pod comprises one or more container, each container executing computer program(s). The combination of the computer program(s) executed by the container(s) implements the software application supported by the pod. The notion of containers is also well known in the art.

Although not represented in FIG. 3 for simplification purposes, the generation of the IP address at step 330 is generally followed by an advertisement of the generated IP address (performed by the processing unit 110 via the communication interface(s) 330). For example, the advertisement of the generated IP address is made by Node 1 to other node(s) 100 (e.g. Nodes 2 and 3), to allow communications between the pod created at step 320 on Node 1 and other pods executed on the other node(s) 100 (e.g. pods on Nodes 2 and 3), using the IP address generated at step 330.

Following are examples of communications performed during the execution of the pod at step 335. For illustration purposes, the pod is POD 1 executed on Node 1. In a first example, the execution of POD 1 on Node 1 generates an IP packet having the IP address generated at step 330 as a source IP address, and the processing unit 110 transmits the IP packet via the communication interface 130 to Node 2 (more specifically to POD 2 executed on Node 2). In a second example, an IP packet having the IP address generated at step 330 as a destination address is received by the processing unit 110 via the communication interface 130 (e.g. from Node 3 and more specifically from POD 3 executed on Node 3), and the IP packet is processed during the execution of POD 1 on Node 1. POD 1 on Node 1 may also use the IP address generated at step 330 to communicate with other entities than pods. For example, POD 1 on Node 1 communicates via the IP address generated at step 330 with a computing device hosting a web server. POD 1 on Node 1 executes a web client for interacting with the web server via the IP address generated at step 330.

The order of the steps performed by the method 300, as represented in FIG. 3, is for illustration purposes only. The order of some of the steps of the method 300 may be changed, without departing from the scope of the presently claimed invention.

The selection at steps 310 and/or 315 can be performed by the processing unit 110 based on an interaction of a user of the node 100 via a user interface of the node 100. Alternatively, the selection at steps 310 and/or 315 is performed by the processing unit 110 based on a command received via the communication interface 130 from the master node 200 (the command is based on an interaction of a user of the master node 200 via a user interface of the master node 200).

Similarly, the creation of the pod at step 320 can be performed by the processing unit 110 based on an interaction of a user of the node 100 via a user interface of the node 100. Alternatively, the creation of the pod at step 320 is performed by the processing unit 110 based on a command received via the communication interface 130 from the master node 200 (the command is based on an interaction of a user of the master node 200 via a user interface of the master node 200).

Different IP addresses can be generated for the same pod, by repeating step 330 for each IP address (before of after the executing of step 335). For example, step 330 is executed a first time for generating an IPv6 address and is repeated for generating an IPv4 address. Then, step 335 is executed.

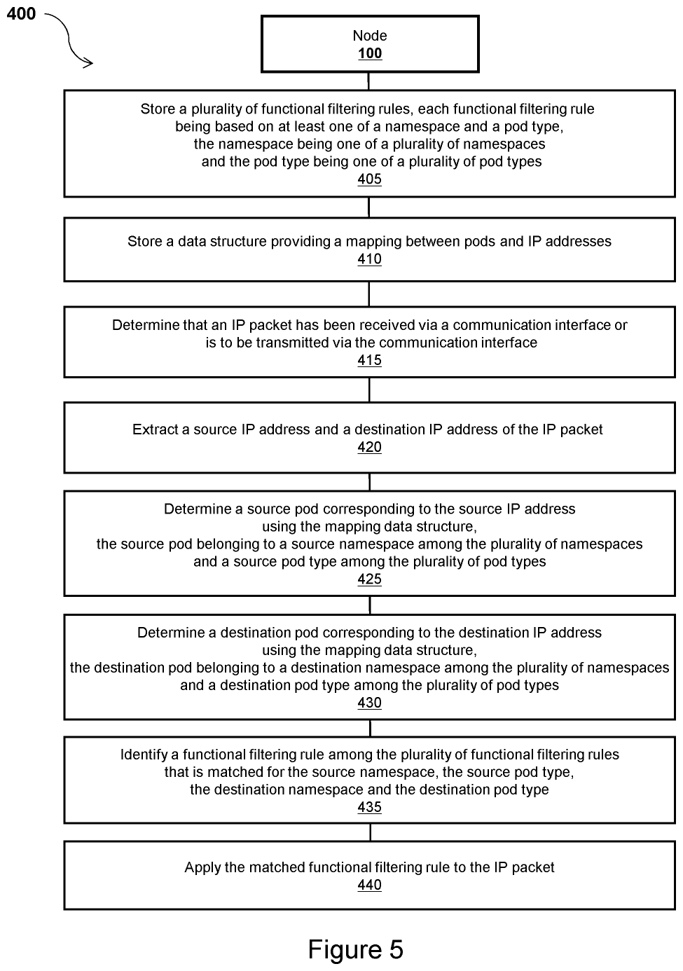

In a first implementation supported by the method 400 represented in FIG. 5, the assumption is made that the IP address generated at step 330 is unique and will not be allocated to another pod (located on the same node or another node). Consequently, any given IP address used as a source address of a packet transmitted by a given pod to another pod, or used as destination address of a packet received by the given pod from another pod, is unique. The given IP address is uniquely associated to the given pod/node on which the given pod is executing.

A data structure can be generated by each node 100, for storing a mapping between the IP addresses and the pods. A given node stores the mapping for the pods executing on the given node, and shares this information with the other nodes. The given node receives information from the other pods, allowing the given node to also store the mapping for the pods executing on the other nodes.

The mechanism for sharing the mapping information between the nodes 100 is out of the scope of the present disclosure. A peer to peer protocol can be used for exchanging the mapping information directly between the nodes 100. Alternatively, a centralized protocol can be used to have the exchange of the mapping information performed under the control of the master node 200.

The following table, based on tables 1 and 2, illustrates an exemplary data structure providing a mapping between the IP addresses and the pods. This data structure is stored at each node 100 (e.g. node 1, node 2 and node 3 of FIG. 2), and optionally also at the master node 200. In the following table 3.

TABLE 3

| | Name | | IP address |
|---|---|---|---|
| Pod | space | Pod type | (IPv6 for illustration purposes) |
| Node 1/ | NSpace_A | app_a01 | 2001:db80:aabb:1001::0001/128 |
| POD 1 | | | |
| Node 1/ | NSpace_A | app_a01 | 2001:db80:aabb:1001::0002/128 |
| POD 2 | | | |
| Node 1/ | NSpace_B | app_b01 | 2001:db80:aabb:1001::0003/128 |
| POD 3 | | | |
| Node 1/ | NSpace_A | app_a02 | 2001:db80:aabb:1001::0004/128 |
| POD 4 | | | |
| Node 2/ | NSpace_A | app_a01 | 2001:db80:aabb:1002::0001/128 |
| POD 1 | | | |
| Node 2/ | NSpace_B | app_b02 | 2001:db80:aabb:1002::0002/128 |
| POD 2 | | | |
| Node 2/ | NSpace_B | app_b01 | 2001:db80:aabb:1002::0003/128 |
| POD 3 | | | |
| Node 3/ | NSpace_A | app_a02 | 2001:db80:aabb:1003::0001/128 |
| POD 1 | | | |
| Node 3/ | NSpace_B | app_b02 | 2001:db80:aabb:1003::0002/128 |
| POD 2 | | | |
| Node 3/ | NSpace_C | app_c01 | 2001:db80:aabb:1003::0003/128 |
| POD 3 | | | |

Using table 3, if an IP packet uses the IPv6 address 2001:db80:aabb:1001:000A:0000:0A01:0002, it is determined that this IPv6 address belongs to POD 2 on node 1. In another example, if an IP packet uses the IPv6 address 2001:db80:aabb:1003:000A:0000:0A02:0001, it is determined that this IPv6 address belongs to POD 1 on node 3.

The namespace and pod type information related to a given pod is stored directly in the mapping data structure, as illustrated in table 3. Alternatively, the namespace and pod type information related to a given pod are not stored in the mapping data structure, but can be retrieved easily once the given pod is identified. For example, the given pod is identified by its pod identifier and an identifier of the node 100 on which it is executed (e.g. a MAC address of the node 100).

Although not represented in table 3 for simplification purposes, several IP addresses may be mapped to a given pod executing on a given node 100 (e.g. an IPv6 and an IPv4 address for at least some of the pods).

Packet filtering of IP (IPv4 or IPv6) packets is well known in the art. Characteristics of IP packets are compared to the one or more condition of the filtering rules, and if the one or more condition of a given filtering rule is satisfied, then the corresponding one or more action is executed. The characteristics of the IP packets being compared include the source IP address, the destination IP address, the destination port (e.g. HTTP), sometimes the source port, the transport protocol (e.g. TCP, UDP), etc. The condition(s) of a filtering rule depends on the characteristic being taken into consideration. For example, whether the source IP address matches a given IP prefix (e.g. 2001:db80:aabb::/48 in IPv6), whether the destination IP address does not match a given IP prefix (e.g. 2001:db80:aabb:1001::/64 in IPv6), whether the destination port or the source port matches a given port value or a given range of port values, whether the transport protocol is TCP or UDP, etc. Examples of actions include allowing or blocking the IP packets matching the condition(s) of a filtering rule, modifying a field of the IP packets matching the condition(s) of a filtering rule, etc. The filtering is applied to IP packets received via the communication interface 130 (ingress filtering) and/or to IP packets generated by the processing unit 110 to be transferred via the communication interface 130.

In the context of an applicative deployment framework supporting the notion of a pod as a containerized software application (e.g. Kubernetes), defining filtering rules applicable to the source and destination IP addresses of the packets may not be scalable. This is due to the fact that such an applicative deployment framework is very dynamic in terms of pods creation and deletion, resulting in a lot of updates to the IP based filtering rules.

Kubernetes provides the functionality of defining functional filtering rules applicable to namespaces and pod types. However, these functional filtering rules are translated into corresponding networking filtering rules applicable to source and destination IP addresses. The networking filtering rules are adapted in real time, based on the corresponding functional filtering rules and the creation and deletion of pods (which is potentially not scalable as mentioned previously).

Consequently, in the current Kubernetes framework, upon reception or transmission of an IP packet by the communication interface 130 of the node 100, networking filtering rules are applied to the IP packet. There is no support in Kubernetes for directly applying functional filtering rules (based on namespaces and pod types) to the IP packet.

In the following, the functional filtering rules are first described. Then the method 400 (represented in FIG. 5) allowing to apply the functional filtering rules to the IP packets received via a communication interface is described.

A functional filtering rule is based on at least one of a namespace or a pod type. For example, a functional filtering rule is defined with respect to one or more namespace. In another example, a functional filtering rule is defined with respect to one or more combination of namespace, and one or more pod type for each names. In still another example, a functional filtering rule is defined with respect to one or more pod type. In this last example, the namespace is not mentioned because it is implicit in the context of the functional filtering rule.

As illustrated in Table 1, in a standard deployment of a pod infrastructure, a plurality of namespaces and a plurality of pod types for each namespace are used. A given namespace used in a functional filtering rule is selected among the plurality of namespaces. For a given namespace, a given pod type used in a functional filtering rule is selected among the plurality of pod types corresponding to the given namespace.

The functional filtering rules enforced by a node 100 are created by a user via a user interface of the node 100 or received via the communication interface 130 of the node 100 from the master node 200 (in the latter case, the rules are created via a user interface of the master node 200). Each functional filtering rule includes one or more condition, and one or more corresponding action.

Following is an exemplary set of ingress functional filtering rules applied to IP traffic received by node 1 (e.g. from node 2 or node 3) and egress functional filtering rules applied to IP traffic generated at node 1 for transmission (e.g. to node 2 or node 3).

Ingress rule 1: allow any traffic to (NSpace_A AND app_a01)

Ingress rule 2: block any traffic to (NSpace_A AND app_a02)

Ingress rule 3: allow any traffic to NSpace_B″ from (NSpace_A OR NSpace_C″)

Ingress rule (4): allow any traffic to NSpace_B from (NSpace_B AND app_b02)

Ingress rule (5): block any traffic to NSpace_B from (NSpace_B AND app_b01)

Egress rule (6): block any traffic from NSpace_A

Egress rule (7): allow any traffic from NSpace_B to (NSpace_C AND app_c01)

Default rule: block any other traffic

These rules are for illustration purposes only. A person skilled in the art would readily understand that other types of rules based on namespaces and pod types are applicable in the context of the present disclosure. For example, as mentioned previously, a rule may include additional types of conditions, such as a destination port/port range, a transport protocol, etc. Furthermore, the terminology used in the rules may vary (e.g. admitting instead of allowing, dropping instead of blocking, etc.). Additionally, a condition may be expressed as a parameter (e.g. namespace of pod type) being equal to a value, different from a value, equal to one of a set of values, different from any of a set of values, etc. Other types of actions are also supported by the present disclosure, such as modifying a field of the packet before allowing the packet.

In a particular implementation, the ingress rules include one more additional rule based on the source IP address of the packet (and optionally a corresponding IP address domain) and the egress filtering rules include one or more additional rule based on the destination IP address of the IP packet (and optionally a corresponding IP address domain). These additional rules support IP Classless Inter-Domain Routing (CIDR) ranges for source and destination entities different from pods.

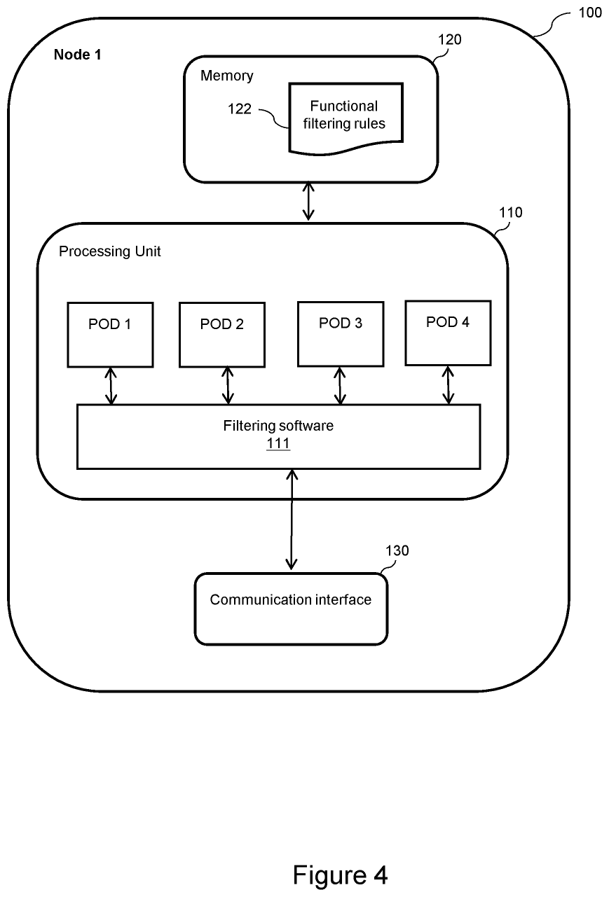

Referring now concurrently to FIGS. 2, 4 and 5, a method 400 for enforcing functional filtering rules in a pod infrastructure is illustrated in FIG. 5. At least some of the steps of the method 400 are performed by the node 100 (Node 1) represented in FIG. 4. As mentioned previously, the pod infrastructure comprises a plurality of namespaces, and for each namespace a plurality of pod types.

The node 100 (Node 1) represented in FIG. 4 corresponds to the node 100 represented in FIG. 1 and the Node 1 represented in FIG. 2. To implement a IP packet filtering functionality, functional filtering rules 122 are stored in the memory 120 and the processing unit 110 executes a filtering software 111 using the function filtering rules 122 for performing IP packet filtering.

A dedicated computer program has instructions for implementing at least some of the steps of the method 400. The instructions are comprised in a non-transitory computer program product (e.g. the memory 120 of the node 100). The instructions, when executed by the processing unit 110 of the node 100, provide for enforcing functional filtering rules in a pod infrastructure. The instructions are deliverable to the node 100 via an electronically-readable media such as a storage media (e.g. CD-ROM, USB key, etc.), or via communication links (e.g. via a communication network through one of the communication interfaces 130 of the node 100). As mentioned previously, the processing unit 110 comprises at least one processor, each processor comprising at least one core.

The method 400 comprises the step 405 of storing a plurality of functional filtering rules 122 in the memory 120 of the node 100 (e.g. in a configuration file comprising all the functional filtering rules 122 used by the filtering software 111). Each functional filtering rule is based on at least one of a namespace and a pod type, where the namespace is one of the plurality of namespaces and the pod type is one of the plurality of pod types defined in the pod infrastructure. Step 405 is executed by the processing unit 110 of the node 100.

The functional filtering rules have been described previously, and include for example the previously mentioned rules (1), (2), (3), (4), (5), (6) and (7).

The method 400 comprises the step 410 of storing a data structure providing a mapping between pods and IP addresses in the memory 120. Step 410 is executed by the processing unit 110 of the node 100.

The mapping data structure has been described previously. Table 3 provides an example of such a mapping data structure.

The method 400 comprises the step 415 of determining that an IP packet has been received via the communication interface 130 of the node 100 or is to be transmitted via the communication interface 130. Step 415 is executed by the processing unit 110 of the node 100.

The method 400 comprises the step 420 of extracting a source IP address and a destination IP address of the IP packet (mentioned at step 415). Step 420 is executed by the processing unit 110 of the node 100.

The method 400 comprises the step 425 of determining a source pod corresponding to the source IP address (extracted at step 420) using the mapping data structure (stored at step 410). The source pod belongs to a source namespace among the plurality of namespaces and a source pod type among the plurality of pod types. Step 425 is executed by the processing unit 110 of the node 100.

The method 400 comprises the step 430 of determining a destination pod corresponding to the destination IP address (extracted at step 420) using the mapping data structure (stored at step 410). The destination pod belongs to a destination namespace among the plurality of namespaces and a destination pod type among the plurality of pod types. Step 430 is executed by the processing unit 110 of the node 100.

The method 400 comprises the step 435 of identifying a functional filtering rule among the plurality of functional filtering rules (stored at step 405) that is matched for the source namespace, the source pod type, the destination namespace and the destination pod type (determined at steps 425 and 430). Step 435 is executed by the processing unit 110 of the node 100.

As is well known in the art, each one of the source namespace, the source pod type, the destination namespace and the destination pod type do not need to be all present in a rule for the rule to be matched. For example, a first rule referring only to the source namespace and the destination namespace may be matched, a second rule referring only the source namespace, the destination namespace and the destination pod type may be matched, etc. (as illustrated in the previously described set of functional filtering rules).

Furthermore, as mentioned previously, additional characteristics of the IP packet may be taken into consideration for determining if a given functional filtering rule is matched, such as a destination port, a transport protocol, etc.

The method 400 comprises the step 440 of applying the matched functional filtering rule (identified at step 435) to the IP packet (mentioned at step 415). Step 440 is executed by the processing unit 110 of the node 100.

Following are examples of the application of steps 415-440 in the context of the pod infrastructure described in FIGS. 2, 4 and table 3, and the previously described set of functional filtering rules.

In a first example (1), an IP packet is received via the communication interface 130 of node 1, with a source IPv6 address 2001:db80:aabb:1002::0001/128 and a destination IPv6 address 2001:db80:aabb:1001::0001/128. The source pod corresponding to the source IPv6 address is POD 1 one node 2, belonging to namespace NSpace_A and pod type app_a01. The destination pod corresponding to the destination IPv6 address is POD 1 on node 1, belonging to namespace NSpace_A and pod type app_a01. Ingress rule (1) is matched and the IPv6 packet is allowed (it is transferred to POD 1 on node 1).

In a second example (2), an IP packet is received via the communication interface 130 of node 1, with a source IPv6 address 2001:db80:aabb:1002::0003/128 and a destination IPv6 address 2001:db80:aabb:1001::0003/128. The source pod corresponding to the source IPv6 address is POD 3 one node 2, belonging to namespace NSpace_B and pod type app_b01. The destination pod corresponding to the destination IPv6 address is POD 3 on node 1, belonging to namespace NSpace_B and pod type app_b01. Ingress rule (5) is matched and the IPv6 packet is blocked (it is not transferred to POD 3 on node 1).

In a third example (3), an IP packet is to be transmitted via the communication interface 130 of node 1, with a source IPv6 address 2001:db80:aabb:1001::0001/128 and a destination IPv6 address 2001:db80:aabb:1003::0001/128. The source pod corresponding to the source IPv6 address is POD 1 one node 1, belonging to namespace NSpace_A and pod type app_a01. The destination pod corresponding to the destination IPv6 address is POD 1 on node 3, belonging to namespace NSpace_A and pod type app_a02. Egress rule (6) is matched and the IPv6 packet is blocked (it is not transmitted via the communication interface 130).

In a fourth example (4), an IP packet is to be transmitted via the communication interface 130 of node 1, with a source IPv6 address 2001:db80:aabb:1001::0003/128 and a destination IPv6 address 2001:db80:aabb:1003::0003/128. The source pod corresponding to the source IPv6 address is POD 3 one node 1, belonging to namespace NSpace_B and pod type app_b01. The destination pod corresponding to the destination IPv6 address is POD 3 on node 3, belonging to namespace NSpace_C and pod type cpp_c01. Egress rule (7) is matched and the IPv6 packet is blocked (it is not transmitted via the communication interface 130).

In a particular implementation of the method 400, the IP packet mentioned at step 415 is the first IP packet of an IP flow. An IP flow is well known in the art. It consists of a sequence of IP packets from a source to a destination, delivered via zero, one or more intermediate routing (e.g. a router) or switching equipment (e.g. an IP switch) over an IP networking infrastructure. An IP flow has a physical layer adapted for the transport of IP packets, such as Ethernet, Synchronous Optical Networking (SONET)/Synchronous Digital Hierarchy (SDH), etc. Several protocol layers are involved in the transport of the IP packets of the IP flow, including a physical layer (e.g. optical or electrical), a link layer (e.g. Media Access Control (MAC) for Ethernet), an Internet layer (e.g. IPv4 or IPv6), a transport layer (e.g. User Datagram Protocol (UDP) or Transmission Control Protocol (TCP)), and one or more application layers (e.g. HTTP or HTTPS). The IP flow provides end-to-end delivery of the applicative payload over the IP networking infrastructure.

The action associated with the matching functional filtering rule identified at step 435 is memorized for application to the following IP packets of the IP flow. The action is directly applied to the following IP packets of the IP flow (e.g. allow or block the following IP packets for an ingress filtering rule and transmit or block the following IP packets for an egress filtering rule). Thus, for the following IP packets of the IP flow, only steps 415 and 440 of the method 400 are applied.

The method 400 has been described with the table 3 comprising IPv6 addresses. However, a person skilled in the art would readily adapt the method 400 to a table 3 comprising IPv4 addresses.

In the case where a source pod is not identified at step 425, the source IP address is used instead of the source namespace and the source pod type at step 435 (as mentioned previously, additional rules supporting CIDR ranges for source and destination entities different from the pods may be included in the functional filtering rules). Similarly, in the case where a destination pod is not identified at step 430, the destination IP address is used instead of the destination namespace and the destination pod type at step 435.

A single communication interface 130 is represented in FIG. 4. However, if the node 100 (e.g. node 1) comprises a plurality of communication interfaces 130, the method 400 is applicable to any of the communication interfaces 130.

As mentioned previously, the method 400 is not limited to the Kubernetes framework, but may be extended to another framework supporting the following features: pods, namespaces and pod types (in a manner similar to the support of these features in the context of Kubernetes).

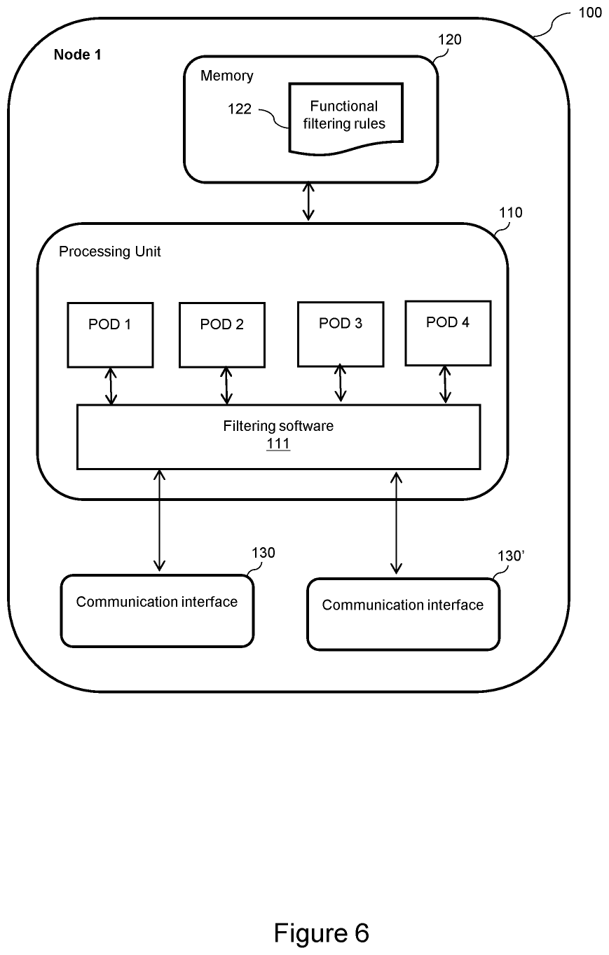

Reference is now made to FIG. 6, which represents the node 100 illustrated in FIG. 4, with two respective communication interfaces 130 and 130′. A first IP address domain is associated to the communication interfaces 130 and a second IP address domain is associated to the communication interfaces 130′.

An IP address domain is well known in the art. The IP address domain is associated to an IP network, where any IP address used within the IP network is unique and well defined. The IP network is implemented via a networking infrastructure, comprising for example routers and firewalls, which preserve the IP network from interferences with other IP networks belonging to other IP domains. The same IP address can be used in two different IP networks associated to respectively two different domains. Network Address Translation (NAT) type functionalities can be used to translate addresses between two different domains, allowing communications between entities respectively located in the two different domains.

Each communication interface of a node 100 is associated to a given network associated to a given IP address domain. For example, referring to FIG. 6, the communication interface 130 is associated to a first IP address domain (e.g. Domain_1) among a plurality of IP address domains and the communication interface 130′ is associated to a second IP address domain (e.g. Domain_2) among the plurality of IP address domains. An administrator of the pod infrastructure is in charge of defining and configuring the plurality of IP address domains used in the pod infrastructure. For a given node 100, the communication interfaces of the node 100 may be associated to the same IP address domain or to different IP address domains. Two communication interfaces of the given node 100 may be associated to the same IP address domain. A mapping between each communication interface and the corresponding IP address domain is stored in the memory 120 of each node 100.

As will be illustrated later in the description, POD 1 and POD 2 represented in FIG. 6 are allocated respective IPv6 addresses associated to the IP address domain Domain_1 and use the communication interface 130 for communications based on these respective IPv6 addresses. POD 3 and POD 4 also represented in FIG. 6 are allocated respective IPv6 addresses associated to the IP address domain Domain_2 and use the communication interface 130′ for communications based on these respective IPv6 addresses.

However, POD 1 and POD 2 may also be allocated respective other IPv6 addresses associated to the IP address domain Domain_2 and use the communication interface 130′ for communications based on these other respective IPv6 addresses. Similarly, POD 3 and POD 4 may also be allocated respective other IPv6 addresses associated to the IP address domain Domain_1 and use the communication interface 130 for communications based on these other respective IPv6 addresses.

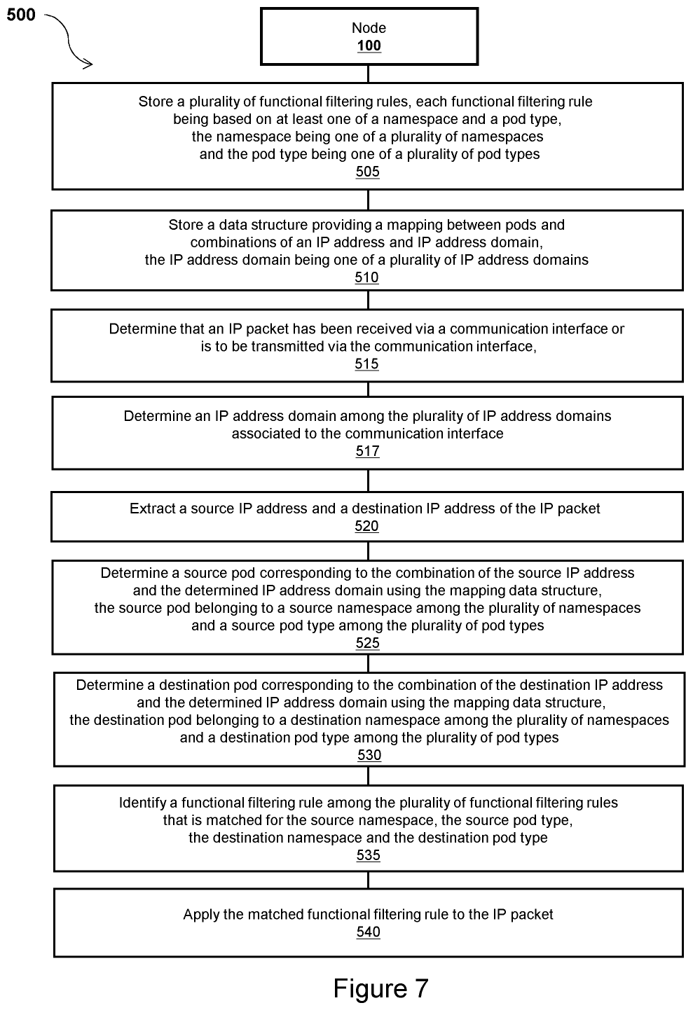

Referring now concurrently to FIGS. 2, 5, 6 and 7, a method 500 for enforcing functional filtering rules in a pod infrastructure supporting IP address domains is illustrated in FIG. 7. At least some of the steps of the method 500 are performed by the node 100 (Node 1) represented in FIG. 6. The method 500 is an adaptation of the method 400 represented in FIG. 5, taking into consideration the usage of a plurality of IP address domains.

A dedicated computer program has instructions for implementing at least some of the steps of the method 500. The instructions are comprised in a non-transitory computer program product (e.g. the memory 120 of the node 100). The instructions, when executed by the processing unit 110 of the node 100, provide for enforcing functional filtering rules in a pod infrastructure supporting IP address domains. The instructions are deliverable to the node 100 via an electronically-readable media such as a storage media (e.g. CD-ROM, USB key, etc.), or via communication links (e.g. via a communication network through one of the communication interfaces 130 of the node 100). As mentioned previously, the processing unit 110 comprises at least one processor, each processor comprising at least one core.

The following table, similar to the previously described table 3, illustrates an exemplary data structure providing a mapping between the pods and combinations of an IP address and an IP address domain. This data structure is stored at each node 100 (e.g. node 1, node 2 and node 3 of FIG. 2), and optionally also at the master node 200.

In the previously described table 3, an IP address is sufficient to identify the corresponding pod executing on a given node (a single default IP address domain is used). In table 4, an IP address is not sufficient to identify the corresponding pod executing on a given node, an associated IP address domain is also needed (since the same IP address can be used in different IP address domains).

TABLE 4

| | Name | | IP | IP address |
|---|---|---|---|---|
| Pod | space | Pod type | Address Domain | (IPv6 for illustration purposes) |
| Node 1/POD 1 | NSpace_A | app_a01 | Domain_1 | 2001:db80:aabb:1001::0001/128 |
| Node 1/POD 2 | NSpace_A | app_a01 | Domain_1 | 2001:db80:aabb:1001::0002/128 |
| Node 1/POD 3 | NSpace_B | app_b01 | Domain_2 | 2001:db80:aabb:1001::0001/128 |
| Node 1/POD 4 | NSpace_A | app_a02 | Domain_2 | 2001:db80:aabb:1001::0002/128 |
| Node 2/POD 1 | NSpace_A | app_a01 | Domain_1 | 2001:db80:aabb:1002::0001/128 |
| Node 2/POD 2 | NSpace_B | app_b02 | Domain_1 | 2001:db80:aabb:1002::0002/128 |
| Node 2/POD 3 | NSpace_B | app_b01 | Domain_2 | 2001:db80:aabb:1002::0001/128 |
| Node 3/POD 1 | NSpace_A | app_a02 | Domain_1 | 2001:db80:aabb:1003::0001/128 |
| Node 3/POD 2 | NSpace_B | app_b02 | Domain_1 | 2001:db80:aabb:1003::0002/128 |
| Node 3/POD 3 | NSpace_C | app_c01 | Domain_2 | 2001:db80:aabb:1003::0001/128 |

As illustrated in table 4, POD 1 and POD 3 on node 1 have the same IPv6 address, but in two different domains. POD 2 and POD 4 on node 1 have the same IPv6 address, but in two different domains. POD 1 and POD 3 on node 2 have the same IPv6 address, but in two different domains. POD 1 and POD 3 on node 3 have the same IPv6 address, but in two different domains.

The method 500 is described with respect to the node 100 represented in FIG. 6, which comprises the two communication interfaces 130 and 130′. However, the method 500 can be generalized to a node 100 comprising any number of communication interfaces (each communication interface being associated to a given IP address domain among a plurality of IP address domains).

The method 500 comprises the step 505 of storing a plurality of functional filtering rules 122 in the memory 120 of the node 100 (e.g. in a configuration file comprising all the functional filtering rules 122 used by the filtering software 111). Each functional filtering rule is based on at least one of a namespace and a pod type, where the namespace is one of the plurality of namespaces and the pod type is one of the plurality of pod types defined in the pod infrastructure. Step 505 is executed by the processing unit 110 of the node 100. Step 505 is similar to step 405 of the method 400.

The functional filtering rules have been described previously, and include for example the previously mentioned rules (1), (2), (3), (4), (5), (6) and (7).

The method 500 comprises the step 510 of storing a data structure providing a mapping between pods and combinations of an IP address and an IP address domain (the IP address domain being one of a plurality of IP address domains), in the memory 120. Step 510 is executed by the processing unit 110 of the node 100.

The mapping data structure has been described previously. Table 4 provides an example of such a mapping data structure.

The method 500 comprises the step 515 of determining that an IP packet has been received via a communication interface (e.g. 130 or 130′) of the node 100 or is to be transmitted via the communication interface (e.g. 130 or 130′). Step 515 is executed by the processing unit 110 of the node 100. Step 515 is similar to step 415 of the method 400. The communication interface (e.g. 130 or 130′) provides access to an IP network associated to an IP address domain (respectively Domain_1 or Domain_2).

The method 500 comprises the step 517 of determining an IP address domain among the plurality of IP address domains associated to the communication interface (mentioned at step 515). Step 517 is executed by the processing unit 110 of the node 100.

The method 500 comprises the step 520 of extracting a source IP address and a destination IP address of the IP packet (mentioned at step 515). Step 520 is executed by the processing unit 110 of the node 100. Step 520 is similar to step 420 of the method 400.

The method 500 comprises the step 525 of determining a source pod corresponding to the combination of the source IP address (extracted at step 520) and the IP address domain (determined at step 517), using the mapping data structure (stored at step 510). The source pod belongs to a source namespace among the plurality of namespaces and a source pod type among the plurality of pod types. Step 525 is executed by the processing unit 110 of the node 100.

The method 500 comprises the step 530 of determining a destination pod corresponding to the combination of the destination IP address (extracted at step 520) and the IP address domain (determined at step 517), using the mapping data structure (stored at step 510). The destination pod belongs to a destination namespace among the plurality of namespaces and a destination pod type among the plurality of pod types. Step 530 is executed by the processing unit 110 of the node 100.

The method 500 comprises the step 535 of identifying a functional filtering rule among the plurality of functional filtering rules (stored at step 505) that is matched for the source namespace, the source pod type, the destination namespace and the destination pod type (determined at steps 525 and 530). Step 535 is executed by the processing unit 110 of the node 100. Step 535 is similar to step 435 of the method 400.

As mentioned previously in relation to the method 400, each one of the source namespace, the source pod type, the destination namespace and the destination pod type do not need to be all present in a rule for the rule to be matched. For example, a first rule referring only to the source namespace and the destination namespace may be matched, a second rule referring only the source namespace, the destination namespace and the destination pod type may be matched, etc. (as illustrated in the previously described set of functional filtering rules).

Furthermore, as mentioned previously, additional characteristics of the IP packet may be taken into consideration for determining if a given functional filtering rule is matched, such as a destination port, a transport protocol, etc.

The method 500 comprises the step 540 of applying the matched functional filtering rule (identified at step 535) to the IP packet (mentioned at step 515). Step 540 is executed by the processing unit 110 of the node 100. Step 540 is similar to step 440 of the method 400.

Following are examples of the application of steps 515-540 in the context of the pod infrastructure described in FIGS. 2, 6 and table 4. These examples are similar to the examples provided for the method 400, but have been adapted to the context of the method 500.

In a first example (1), an IP packet is received via the communication interface 130 of node 1, with a source IPv6 address 2001:db80:aabb:1002::0001/128 and a destination IPv6 address 2001:db80:aabb:1001::0001/128 belonging to the IP address domain Domain_1. The source pod corresponding to the source IPv6 address in the IP address domain Domain_1 is POD 1 one node 2, belonging to namespace NSpace_A and pod type app_a01. The destination pod corresponding to the destination IPv6 address in the IP address domain Domain_1 is POD 1 on node 1, belonging to namespace NSpace_A and pod type app_a01. Ingress rule (1) is matched and the IPv6 packet is allowed (it is transferred to POD 1 on node 1).

In a second example (2), an IP packet is received via the communication interface 130′ of node 1, with a source IPv6 address 2001:db80:aabb:1002::0001/128 and a destination IPv6 address 2001:db80:aabb:1001::0001/128 belonging to the IP address domain Domain_2. The source pod corresponding to the source IPv6 address in the IP address domain Domain_2 is POD 3 one node 2, belonging to namespace NSpace_B and pod type app_b01. The destination pod corresponding to the destination IPv6 address in the IP address domain Domain_2 is POD 3 on node 1, belonging to namespace NSpace_B and pod type app_b01. Ingress rule (5) is matched and the IPv6 packet is blocked (it is not transferred to POD 3 on node 1).

In a third example (3), an IP packet is to be transmitted via the communication interface 130 of node 1, with a source IPv6 address 2001:db80:aabb:1001::0001/128 and a destination IPv6 address 2001:db80:aabb:1003::0001/128 belonging to the IP address domain Domain_1. The source pod corresponding to the source IPv6 address is POD 1 one node 1, belonging to namespace NSpace_A and pod type app_a01. The destination pod corresponding to the destination IPv6 address is POD 1 on node 3, belonging to namespace NSpace_A and pod type app_a02. Egress rule (6) is matched and the IPv6 packet is blocked (it is not transmitted via the communication interface 130).

In a fourth example (4), an IP packet is to be transmitted via the communication interface 130′ of node 1, with a source IPv6 address 2001:db80:aabb:1001::0001/128 and a destination IPv6 address 2001:db80:aabb:1003::0001/128 belonging to the IP address domain Domain_2. The source pod corresponding to the source IPv6 address is POD 3 one node 1, belonging to namespace NSpace_B and pod type app_b01. The destination pod corresponding to the destination IPv6 address is POD 3 on node 3, belonging to namespace NSpace_C and pod type cpp_c01. Egress rule (7) is matched and the IPv6 packet is blocked (it is not transmitted via the communication interface 130).

In a particular implementation of the method 500 (previously mentioned in reference to the method 400), the IP packet mentioned at step 515 is the first IP packet of an IP flow. The action associated with the matching functional filtering rule identified at step 535 is memorized for application to the following IP packets of the IP flow. The action is directly applied to the following IP packets of the IP flow (e.g. allow or block the following IP packets for an ingress filtering rule and transmit or block the following IP packets for an egress filtering rule). Thus, for the following IP packets of the IP flow, only steps 515 and 540 of the method 500 are applied.

The method 500 has been described with the table 4 comprising IPv6 addresses. However, a person skilled in the art would readily adapt the method 500 to a table 4 comprising IPv4 addresses.

In the case where a source pod is not identified at step 525, the source IP address and the IP address domain is used instead of the source namespace and the source pod type at step 535 (as mentioned previously, additional rules supporting CIDR ranges for source and destination entities different from the pods may be included in the functional filtering rules). Similarly, in the case where a destination pod is not identified at step 530, the destination IP address and the IP address domain is used instead of the destination namespace and the destination pod type at step 535.

As mentioned previously, the method 500 is not limited to the Kubernetes framework, but may be extended to another framework supporting the following features: pods, namespaces and pod types (in a manner similar to the support of these features in the context of Kubernetes).

The present disclosure has been described in the context of a pod infrastructure comprising a plurality of namespaces, and a plurality of pod types for each namespace. This context is realistic for large scale infrastructures. However, the present disclosure in also applicable in the context of a pod infrastructure comprising a single namespace (e.g. a single default namespace) and a plurality of pod types associated to the single namespace. The present disclosure is also applicable for a namespace having a single associated pod type.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A method for enforcing functional filtering rules in a pod infrastructure, the method comprising:
storing in a memory of a computing device a plurality of functional filtering rules, each functional filtering rule being based on at least one of a namespace and a pod type, the namespace being one of a plurality of namespaces and the pod type being one of a plurality of pod types;
storing in the memory of the computing device a data structure providing a mapping between pods and Internet Protocol (IP) addresses;
determining that an IP packet has been received via a communication interface of the computing device or is to be transmitted via the communication interface of the computing device;
extracting by a processing unit of the computing device a source IP address and a destination IP address of the IP packet;
determining by the processing unit of the computing device a source pod corresponding to the source IP address using the mapping data structure, the source pod belonging to a source namespace among the plurality of namespaces and a source pod type among the plurality of pod types;
determining by the processing unit of the computing device a destination pod corresponding to the destination IP address using the mapping data structure, the destination pod belonging to a destination namespace among the plurality of namespaces and a destination pod type among the plurality of pod types;
identifying by the processing unit of the computing device a functional filtering rule among the plurality of functional filtering rules that is matched for the source namespace, the source pod type, the destination namespace and the destination pod type; and
applying by the processing unit of the computing device the matched functional filtering rule to the IP packet.

2. The method of claim 1, wherein the IP packet is received via the communication interface of the computing device, the matched functional filtering rule performs ingress filtering, and the IP packet is either allowed or blocked based on the matched functional filtering rule.

3. The method of claim 2, wherein the IP packet is the first IP packet of an IP flow, and an action applicable to the IP flow is determined and stored in the memory of the computing device, the action consisting in allowing the following IP packets of the IP flow if the first IP packet is allowed or blocking the following IP packets of the IP flow if the first IP packet is blocked.

4. The method of claim 1, wherein the IP packet is to be transmitted via the communication interface of the computing device, the matched functional filtering rule performs egress filtering, and the IP packet is either transmitted or blocked based on the matched functional filtering rule.

5. The method of claim 4, wherein the IP packet is the first IP packet of an IP flow, and an action applicable to the IP flow is determined and stored in the memory of the computing device, the action consisting in transmitting the following IP packets of the IP flow if the first IP packet is transmitted or blocking the following IP packets of the IP flow if the first IP packet is blocked.

6. The method of claim 1, wherein the matched functional filtering rule matches one or more additional characteristic of the IP packet, the one or more additional characteristic of the IP packet comprising at least one of a destination port and a transport protocol.

7. The method of claim 1, wherein the IP packet is an IPv4 or and IPv6 packet.

8. The method of claim 1, wherein the source and destination pods are Kubernetes pods.

9. The method of claim 1, wherein the IP packet is received via the communication interface of the computing device and the destination pod is executed by the processing unit of the computing device, the execution of the destination pod comprising executing a containerized software application.

10. The method of claim 1, wherein the IP packet is to be transmitted via the communication interface of the computing device and the source pod is executed by the processing unit of the computing device, the execution of the source pod comprising executing a containerized software application.

11. A computing device comprising:
memory for:
storing a plurality of functional filtering rules, each functional filtering rule being based on at least one of a namespace and a pod type, the namespace being one of a plurality of namespaces and the pod type being one of a plurality of pod types; and
storing a data structure providing a mapping between pods and Internet Protocol (IP) addresses;
a communication interface; and
a processing unit comprising at least one processor for:
determining that an IP packet has been received via the communication interface or is to be transmitted via the communication interface;
extracting a source IP address and a destination IP address of the IP packet;
determining a source pod corresponding to the source IP address using the mapping data structure, the source pod belonging to a source namespace among the plurality of namespaces and a source pod type among the plurality of pod types;
determining a destination pod corresponding to the destination IP address using the mapping data structure, the destination pod belonging to a destination namespace among the plurality of namespaces and a destination pod type among the plurality of pod types;
identifying a functional filtering rule among the plurality of functional filtering rules that is matched for the source namespace, the source pod type, the destination namespace and the destination pod type; and
applying the matched functional filtering rule to the IP packet.

12. A method for enforcing functional filtering rules in a pod infrastructure supporting Internet Protocol (IP) address domains, the method comprising:
storing in a memory of a computing device a plurality of functional filtering rules, each functional filtering rule being based on at least one of a namespace and a pod type, the namespace being one of a plurality of namespaces and the pod type being one of a plurality of pod types;
storing in the memory of the computing device a data structure providing a mapping between pods and combinations of an Internet Protocol (IP) address and an IP address domain, the IP address domain being one of a plurality of IP address domains;
determining that an IP packet has been received via a communication interface of the computing device or is to be transmitted via the communication interface of the computing device;
determining by the processing unit of the computing device an IP address domain among the plurality of IP address domains associated to the communication interface;
extracting by the processing unit of the computing device a source IP address and a destination IP address of the IP packet;
determining by the processing unit of the computing device a source pod corresponding to the combination of the source IP address and the determined IP address domain using the mapping data structure, the source pod belonging to a source namespace among the plurality of namespaces and a source pod type among the plurality of pod types;
determining by the processing unit of the computing device a destination pod corresponding to the combination of the destination IP address and the determined IP address domain using the mapping data structure, the destination pod belonging to a destination namespace among the plurality of namespaces and a destination pod type among the plurality of pod types;
identifying by the processing unit of the computing device a functional filtering rule among the plurality of functional filtering rules that is matched for the source namespace, the source pod type, the destination namespace and the destination pod type; and
applying by the processing unit of the computing device the matched functional filtering rule to the IP packet.

13. The method of claim 12, further comprising:
determining that another IP packet has been received via another communication interface of the computing device or is to be transmitted via the other communication interface of the computing device;
determining by the processing unit of the computing device another IP address domain among the plurality of IP address domains associated to the other communication interface;
extracting by the processing unit of the computing device a source IP address and a destination IP address of the other IP packet;
determining by the processing unit of the computing device a source pod corresponding to the combination of the source IP address and the determined other IP address domain using the mapping data structure, the source pod belonging to a source namespace among the plurality of namespaces and a source pod type among the plurality of pod types;
determining by the processing unit of the computing device a destination pod corresponding to the combination of the destination IP address and the determined other IP address domain using the mapping data structure, the destination pod belonging to a destination namespace among the plurality of namespaces and a destination pod type among the plurality of pod types;
identifying by the processing unit of the computing device a functional filtering rule among the plurality of functional filtering rules that is matched for the source namespace, the source pod type, the destination namespace and the destination pod type; and
applying by the processing unit of the computing device the matched functional filtering rule to the IP packet.

14. The method of claim 12, wherein the IP packet is received via the communication interface of the computing device, the matched functional filtering rule performs ingress filtering, and the IP packet is either allowed or blocked based on the matched functional filtering rule.

15. The method of claim 14, wherein the IP packet is the first IP packet of an IP flow, and an action applicable to the IP flow is determined and stored in the memory of the computing device, the action consisting in allowing the following IP packets of the IP flow if the first IP packet is allowed or blocking the following IP packets of the IP flow if the first IP packet is blocked.

16. The method of claim 12, wherein the IP packet is to be transmitted via the communication interface of the computing device, the matched functional filtering rule performs egress filtering, and the IP packet is either transmitted or blocked based on the matched functional filtering rule.

17. The method of claim 16 wherein the IP packet is the first IP packet of an IP flow, and an action applicable to the IP flow is determined and stored in the memory of the computing device, the action consisting in transmitting the following IP packets of the IP flow if the first IP packet is transmitted or blocking the following IP packets of the IP flow if the first IP packet is blockped.

18. The method of claim 12, wherein the matched functional filtering rule matches one or more additional characteristic of the IP packet, the one or more additional characteristic of the IP packet comprising at least one of a destination port and a transport protocol.

19. The method of claim 12, wherein the IP packet is an IPv4 packet and the IP address domain is an IPv4 address domain, or the IP packet is an IPv6 packet and the IP address domain is an IPv6 address domain.

20. The method of claim 12, wherein the source and destination pods are Kubernetes pods.

21. The method of claim 12, wherein the IP packet is received via the communication interface of the computing device and the destination pod is executed by the processing unit of the computing device, the execution of the destination pod comprising executing a containerized software application.

22. The method of claim 12, wherein the IP packet is to be transmitted via the communication interface of the computing device and the source pod is executed by the processing unit of the computing device, the execution of the source pod comprising executing a containerized software application.

23. A computing device comprising:
memory for:
storing a plurality of functional filtering rules, each functional filtering rule being based on at least one of a namespace and a pod type, the namespace being one of a plurality of namespaces and the pod type being one of a plurality of pod types; and
storing a data structure providing a mapping between pods and combinations of an Internet Protocol (IP) address and an IP address domain, the IP address domain being one of a plurality of IP address domains;
a communication interface; and
a processing unit comprising at least one processor for:
determining that an IP packet has been received via the communication interface or is to be transmitted via the communication interface;
determining an IP address domain among the plurality of IP address domains associated to the communication interface;
extracting a source IP address and a destination IP address of the IP packet;
determining a source pod corresponding to the combination of the source IP address and the determined IP address domain using the mapping data structure, the source pod belonging to a source namespace among the plurality of namespaces and a source pod type among the plurality of pod types;
determining a destination pod corresponding to the combination of the destination IP address and the determined IP address domain using the mapping data structure, the destination pod belonging to a destination namespace among the plurality of namespaces and a destination pod type among the plurality of pod types;
identifying a functional filtering rule among the plurality of functional filtering rules that is matched for the source namespace, the source pod type, the destination namespace and the destination pod type; and
applying the matched functional filtering rule to the IP packet.
